(19) United States
(12) Patent Application Publication
(10) Pub. No.: US 2021/0295727 A1
(43) Pub. Date: Sep. 23, 2021

(54) INFORMATION PROCESSING APPARATUS, INFORMATION PROCESSING METHOD, AND PROGRAM

(71) Applicant: SONY CORPORATION, TOKYO (JP)

(72) Inventors: KAZUHIRO WATANABE, TOKYO (JP); YOSHIHIKO IKENAGA, TOKYO (JP); MARIKA NOZUE, TOKYO (JP)

(21) Appl. No.: 17/250,485

(22) PCT Filed: Jul. 11, 2019
(86) PCT No.: PCT/JP2019/027592

§ 371 Date: Jan. 27, 2021

(30) Foreign Application Priority Data
Aug. 3, 2018 (JP) 2018-147106

(51) Int. Cl. G09B 7/04; G06F 3/0482; G06F 3/0481; H04L 12/58; G09B 19/00

(52) U.S. Cl. CPC G09B 7/04; G06F 3/0482; G09B 19/00; H04L 51/02; G06F 3/04817

(57) ABSTRACT

An information processing apparatus (2) including a control unit (200) configured to: perform control for sequentially displaying question data in a conversational format; control display in the conversational format so as to proceed in accordance with a transition trigger operation by a learner; record a part where an advice request operation has been performed by the learner with respect to the display in the conversational format being sequentially displayed; and calculate comprehension of the learner based on a part where the advice request operation has been performed.

### TECHNICAL FIELD

The present disclosure relates to an information processing apparatus, an information processing method, and a program.

### BACKGROUND ART

Recent developments in communication technology have given rise to proposals of techniques for providing users with online courses or presenting questions and eliciting answers via a network such as the Internet.

For example, PTL 1 described below discloses providing a user with a question in accordance with a degree of learning of the user.

### CITATION LIST

### Patent Literature

[PTL 1]

WO 2016/088463

### SUMMARY

### Technical Problem

One question presentation format that is used when presenting a user with a question is a format which poses a condition of the question, an instruction for the question, or the like as a sentence. While a direct style as typified by “da/dearu style” or a distal style as typified by “desu/masu style” is used as a style of such a sentence question, since sentences are written in an objective and monotonous manner in both styles, a sense of immersion by a learner is low and may lead to tediousness or a decline in concentration.

In addition, while a degree of learning is calculated based on contents of answers (a percentage of correct answers to a question, times required to provide an answer, results of a questionnaire with respect to the question, and the like), with a sentence question, cases may be envisaged where a learner is unable to comprehend a content of a question statement midway through reading the question statement. In conventional art, it is difficult to assess how much of a sentence question a learner has read and comprehended.

In consideration thereof, the present disclosure proposes an information processing apparatus, an information processing method, and a program which are capable of imparting a sense of immersion to a question and more appropriately calculating comprehension of a learner by sequentially displaying a question statement in a conversational format.

### Solution to Problem

The present disclosure proposes an information processing apparatus including a control unit configured to: perform control for sequentially displaying question data in a conversational format; control display in the conversational format so as to proceed in accordance with a transition trigger operation by a learner; record a part where an advice request operation has been performed by the learner with respect to the display in the conversational format being sequentially displayed; and calculate comprehension of the learner based on a part where the advice request operation has been performed.

The present disclosure proposes an information processing method including the steps carried out by a processor of: performing control for sequentially displaying question data in a conversational format; controlling display in the conversational format so as to proceed in accordance with a transition trigger operation by a learner; recording a part where an advice request operation has been performed by the learner with respect to the display in the conversational format being sequentially displayed; and calculating comprehension of the learner based on a part where the advice request operation has been performed.

The present disclosure proposes a program for causing a computer to function as a control unit configured to: perform control for sequentially displaying question data in a conversational format; control display in the conversational format so as to proceed in accordance with a transition trigger operation by a learner; record a part where an advice request operation has been performed by the learner with respect to the display in the conversational format being sequentially displayed; and calculate comprehension of the learner based on a part where the advice request operation has been performed.

### Advantageous Effect of Invention

As described above, according to the present disclosure, a sense of immersion to a question can be imparted and comprehension of a learner can be more appropriately calculated by sequentially displaying a question statement in a conversational format.

It should be noted that the advantageous effect described above is not necessarily restrictive and, in addition to the advantageous effect described above or in place of the advantageous effect described above, any of the advantageous effects described in the present specification or other advantageous effects that can be comprehended from the present specification may be produced.

### BRIEF DESCRIPTION OF DRAWINGS

FIG. 1 is a diagram for explaining an outline of a learning support system according to an embodiment of the present disclosure.

FIG. 2 is a block diagram showing an example of a configuration of a question management server according to the present embodiment.

FIG. 3 is a diagram showing an example of question data according to the present embodiment.

FIG. 4 is a screen transition diagram for explaining an example of display of question data in a conversational format according to the present embodiment.

FIG. 5 is a screen transition diagram for explaining an example of display of question data in a conversational format according to the present embodiment.

FIG. 6 is a screen transition diagram for explaining an example of display of question data in a conversational format according to the present embodiment.

FIG. 7 is a diagram for explaining an example of display of hint information having been registered in advance according to the present embodiment.

FIG. 8 is a diagram for explaining an example of display of a similar-type question with a low level of difficulty having been registered in advance according to the present embodiment.

FIG. 9 is a diagram for explaining an example of a case of notifying a teacher terminal when an “I don't understand” button is tapped according to the present embodiment.

FIG. 10 is a diagram showing an example of a display screen of the teacher terminal according to the present embodiment.

FIG. 11 is a diagram showing an example of a question editing screen according to the present embodiment.

FIG. 12 is a flow chart showing an example of a flow of operation processing of the learning support system according to the present embodiment.

FIG. 13A is a diagram showing a display example of a backchannel response by each learner during learning in a group format according to the present embodiment.

FIG. 13B is a diagram showing another display example of a backchannel response by each learner during learning in a group format according to the present embodiment.

FIG. 14 is a diagram for explaining a display example when the “I don't understand” button is pressed during learning in a group format according to the present embodiment.

FIG. 15 is a diagram for explaining an example of hiding a correct answer by another participant during learning in a group format according to the present embodiment.

FIG. 16 is a diagram for explaining a case where a similar question is presented to a person having provided a correct answer during learning in a group format according to the present embodiment.

FIG. 17 is a diagram for explaining a list screen of participant progress during learning in a group format according to the present embodiment.

### DESCRIPTION OF EMBODIMENTS

Hereinafter, a preferred embodiment of the present disclosure will be described in detail with reference to the accompanying drawings. In the present specification and the drawings, components substantially having a same functional configuration will be denoted by same reference signs and overlapping descriptions thereof will be omitted.

In addition, descriptions will be given in the following order.

1. Outline of learning support system according to embodiment of present disclosure

2. Configuration example of question management server 2

3. Operation processing

4. Example of application to learning in group format

5. Summary

<1. Outline of Learning Support System According to Embodiment of Present Disclosure>

A learning support system according to an embodiment of the present disclosure enables, when presenting a question to a learner using a computer, a sense of immersion to the question to be imparted and comprehension of the learner to be more appropriately calculated by sequentially displaying a question statement in a conversational format.

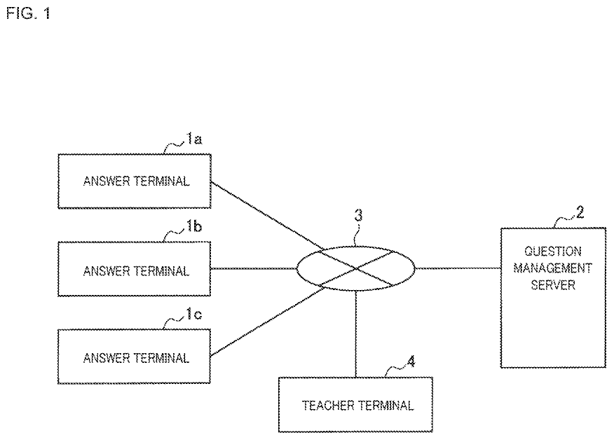

FIG. 1 is a diagram for explaining an overall configuration of the learning support system according to the embodiment of the present disclosure. As shown in FIG. 1, the learning support system according to the present embodiment includes an answer terminal 1 and a question management server 2 which are connected via a network 3. In addition, a teacher terminal 4 may be further connected to the network 3.

The answer terminal 1 is an information processing terminal that is realized by, for example, a PC (personal computer), a tablet terminal, a smartphone, a mobile phone terminal, or a transmissive/non-transmissive HMD (Head Mounted Display). The answer terminal 1 displays question data received from the question management server 2 on a display unit and transmits answer data input by a learner to the question management server 2.

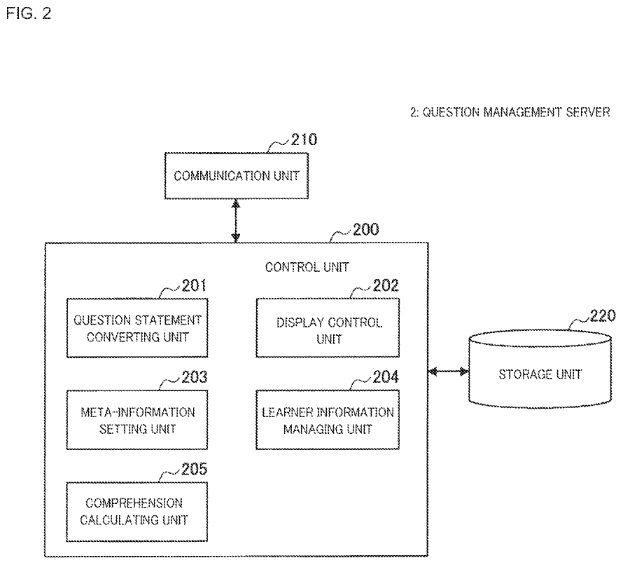

The question management server 2 has a database for storing question data. As the question data, a question that has already been digitized may be imported, a question may be manually registered by a creator of the question, or a question may be registered by capturing hand-written or printed characters with a scanner or the like and computerizing the captured characters. “Question data” includes data related to a question (such as question statement data) and data related to a correct answer (a correct answer or commentary data). In addition, the question data may be a text, an image (a still image or a moving image), audio, or the like. The question management server 2 transmits the question data to the answer terminal 1 and receives answer data transmitted from the answer terminal 1. In addition, the question management server 2 can also perform corrective feedback processing with respect to the answer data. Specific functions of the question management server 2 will be described later with reference to FIG. 2.

The teacher terminal 4 is an information processing terminal in a similar manner to the answer terminal 1 and is realized by, for example, a PC (personal computer), a tablet terminal, a smartphone, a mobile phone terminal, or a transmissive/non-transmissive HMD (Head Mounted Display). The teacher terminal 4 is capable of checking progress and contents of an answer of each learner using the answer terminal 1 and performing exchange of messages with each learner.

This concludes the description of an outline of the learning support system according to the embodiment of the present disclosure. Next, a specific configuration of the question management server 2 included in the learning support system according to the present embodiment will be described.

<2. Configuration Example of Question Management Server 2>

FIG. 2 is a block diagram showing an example of a configuration of the question management server 2 according to the present embodiment. As shown in FIG. 2, the question management server 2 includes a control unit 200, a communication unit 210, and a storage unit 220.

(Control Unit 200)

The control unit 200 functions as an arithmetic processing apparatus and a control apparatus and controls whole operations inside the question management server 2 in accordance with various programs. The control unit 200 is realized by an electronic circuit such as a CPU (Central Processing Unit), a microprocessor, or the like. In addition, the control unit 200 may include a ROM (Read Only Memory) for storing programs, operation parameters, and the like to be used and a RAM (Random Access Memory) for temporarily storing parameters and the like that change from time to time.

Furthermore, the control unit 200 according to the present embodiment also functions as a question statement converting unit 201, a display control unit 202, a meta-information setting unit 203, a learner information managing unit 204, and a comprehension calculating unit 205.

The question statement converting unit 201 performs processing for converting question data into a conversational format. Specifically, for example, the question statement converting unit 201 performs processing of dividing a question statement (text data) included in the question data into clauses, paragraphs, or the like and changing a style of the text into a conversational tone. In addition, the question statement converting unit 201 automatically inserts a backchannel response, a question, or the like by the learner into a conversation using a name, an icon image, or the like of the learner. Furthermore, the question statement converting unit 201 can insert image information included in the question data as a part of a speech bubble of a conversation. In this manner, since converting a question statement into a conversational format enables monotony of the question statement to be broken and automatically inserting a backchannel response or the like by a learner enables the question statement to be read in a mode of a conversation with the learner, it is expected that a sense of immersion of the learner can be increased and the learner's interest to be engaged. It should be noted that, in addition to a text and an image, information such as audio and video can also be embedded into a speech bubble that is displayed as conversation. By clicking the embedded information, the learner can maximize or reproduce the information.

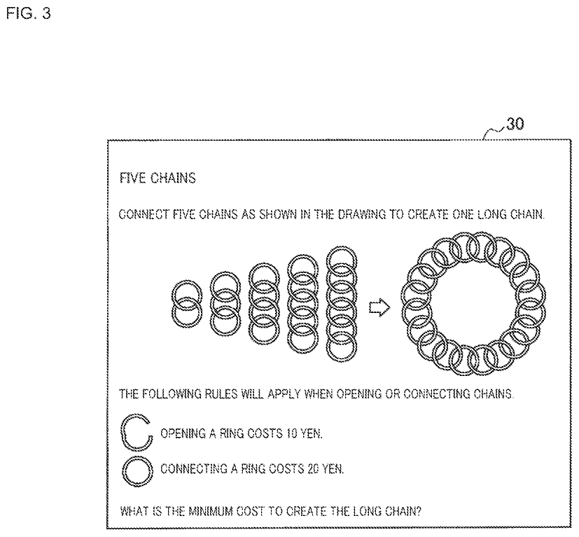

The display control unit 202 performs control so as to sequentially display, on the answer terminal 1, question data (a conversation sentence) in a conversational format having been converted as described above. Specifically, the display control unit 202 performs display control so as to sequentially advance a conversation in accordance with a transition trigger operation by a learner operating the answer terminal 1. An example of changing question data into a conversational format and displaying the question data in the conversational format will now be described with reference to FIGS. 3 to 6.

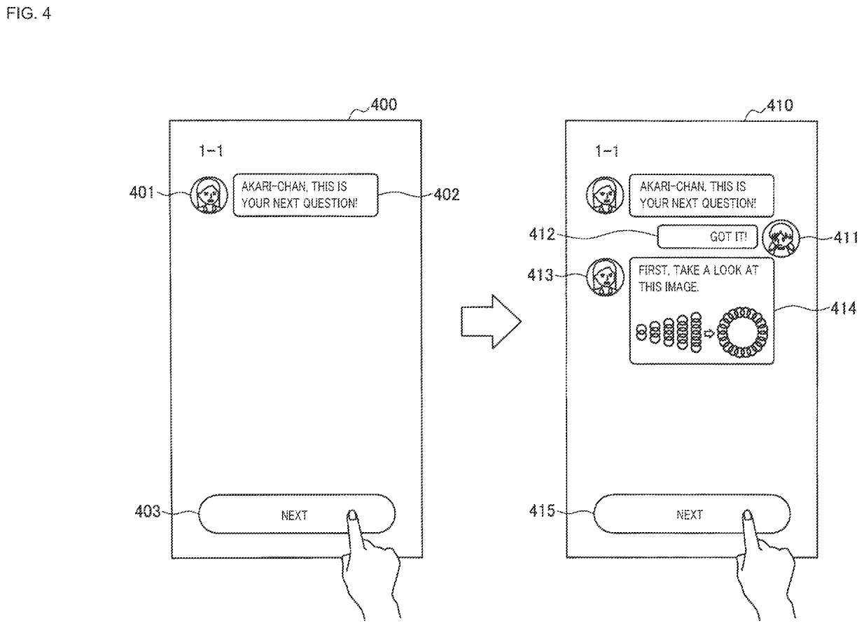

FIG. 3 is a diagram showing an example of question data 30 according to the present embodiment. In addition, FIGS. 4 to 6 are screen transition diagrams for explaining an example of display in a conversational format having been generated based on the question data 30 shown in FIG. 3.

For example, from a first sentence that reads “Connect five chains as shown in the drawing to create one long chain” of the question statement data as shown in FIG. 3, the question statement converting unit 201 generates conversation sentences such as “First, take a look at this image (insert an image)” and “You are now going to connect five chains to create one long chain” and causes the display control unit 202 to display the conversation sentences on the answer terminal 1 as utterances made by a teacher on a conversation screen between the teacher and a learner. In addition, from a second sentence that reads “The following rules will apply when opening or connecting chains” of the question statement data, a conversation sentence such as “But keep in mind that there are rules that you must follow when connecting the chains” can be generated. Connectives may be added to a conversation sentence whenever appropriate. A change algorithm to a conversational tone is not particularly limited and a known tone change algorithm may be used.

In addition, as described above, the display control unit 202 performs display control so as to advance a conversation in accordance with a transition trigger operation by a learner. Specifically, as shown in the screen transition diagrams of FIGS. 4 to 6, conversation sentences are sequentially displayed by displaying a “next” button and displaying a next conversation sentence when the learner comprehends contents and taps the “next” button (in other words, when performing a transition trigger operation).

For example, as shown on a screen 400 in FIG. 4, the display control unit 202 first displays a teacher icon image 401, a speech bubble image 402 that displays a line notifying a start of a question, and a “next” button 403. As a line for notifying the start of a question, using information (in this case, a name “Akari-chan”) of a learner, by addressing the learner by name and calling out “Akari-chan, this is your next question!”, the attention and interest of the learner can be engaged.

Next, when the learner taps the “next” button 403, as shown on a screen 410 in FIG. 4, the display control unit 202 displays a learner icon image 411 and a speech bubble image 412 that displays a backchannel response such as “okay”, automatically issues a response by the learner on the conversation screen, and further displays a teacher icon image 413 and a speech bubble image 414 that displays a conversation sentence reading “First, take a look at this image.” having been generated based on the first sentence of the question statement data. Image information included in the question statement data is also inserted into the speech bubble image 414. In this manner, by automatically inserting a backchannel response or the like by the learner into a conversation screen and displaying a next conversation in accordance with a tap of the “next” button 403 that indicates that the learner has comprehended contents and is to proceed to the next sentence, a conversation between a presenter of a question and the learner is automatically established and a sense of immersion of the learner viewing the conversation can be increased.

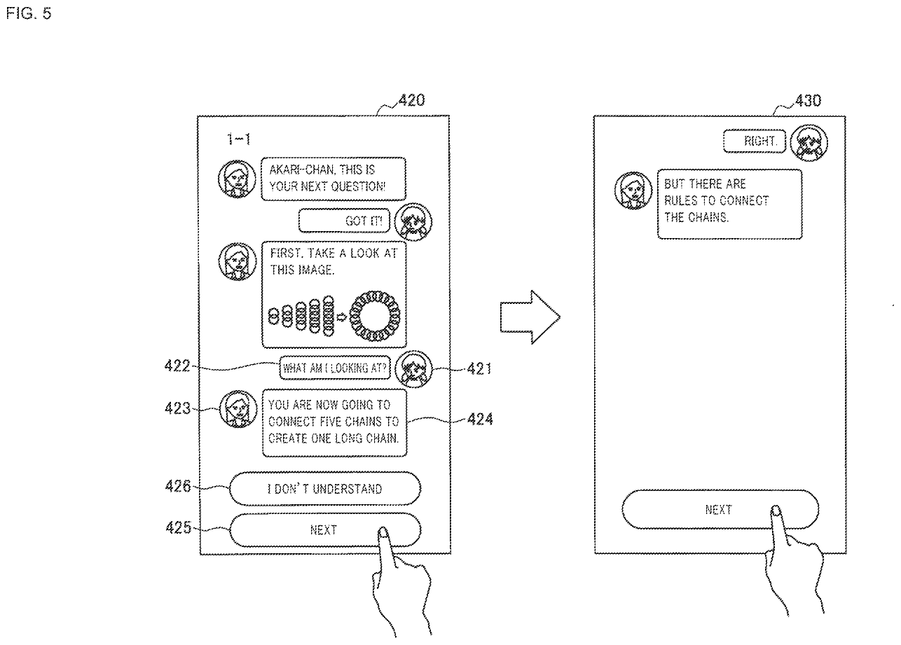

Next, when the learner is able to comprehend displayed contents, the learner taps a “next” button 415. When the “next” button 415 is tapped, as shown on a screen 420 in FIG. 5, the display control unit 202 automatically displays a learner icon image 421 and a speech bubble image 422 that displays a backchannel response/question such as “What am I looking at?”. The automatically-displayed backchannel response/question by the learner may be randomly selected (or generated) from several patterns prepared in advance or an appropriate backchannel response with respect to an immediately-previous line by the presenter may be selected (or generated). Alternatively, a backchannel response/question may be generated by extracting a keyword included in the immediately-previous line by the presenter. For example, with respect to a line by the presenter reading “You must follow a rule of XXX”, a question using a keyword “rule” that reads “What kind of rule?” is generated.

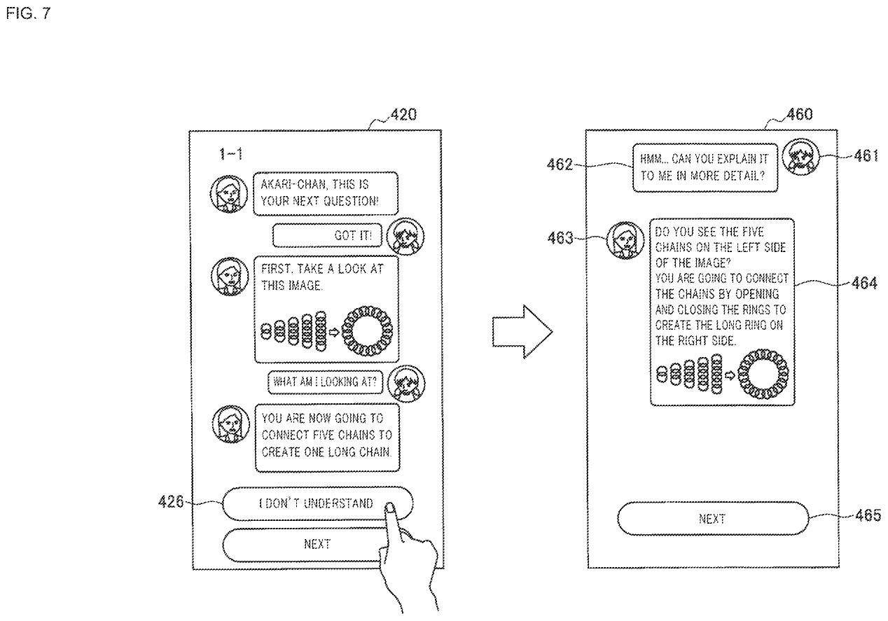

Next, as shown on the screen 420 in FIG. 5, the display control unit 202 displays a teacher icon image 423 and a speech bubble image 424 showing a conversation sentence reading “You are now going to connect five chains to create one long chain” having been generated based on the first sentence of the question statement data. When the learner is able to comprehend the conversation thus far, the learner taps a “next” button 425. In addition, an “I don't understand” button 426 that is selected when the conversation thus far cannot be comprehended is displayed on the screen 420. The “I don't understand” button 426 may be displayed when corresponding hint information or similar-question information is registered. Processing when the “I don't understand” button 426 is tapped will be described later with reference to FIG. 7. It should be noted that the “transition trigger operation by a learner” is not limited to a tap of the “next” button or the like and may be a predetermined operation instructing that the learner has comprehended contents and is to proceed to a next conversation such as a predetermined touch operation (such as a double tap) on a screen, a scroll operation, a movement of a line of sight, or the like.

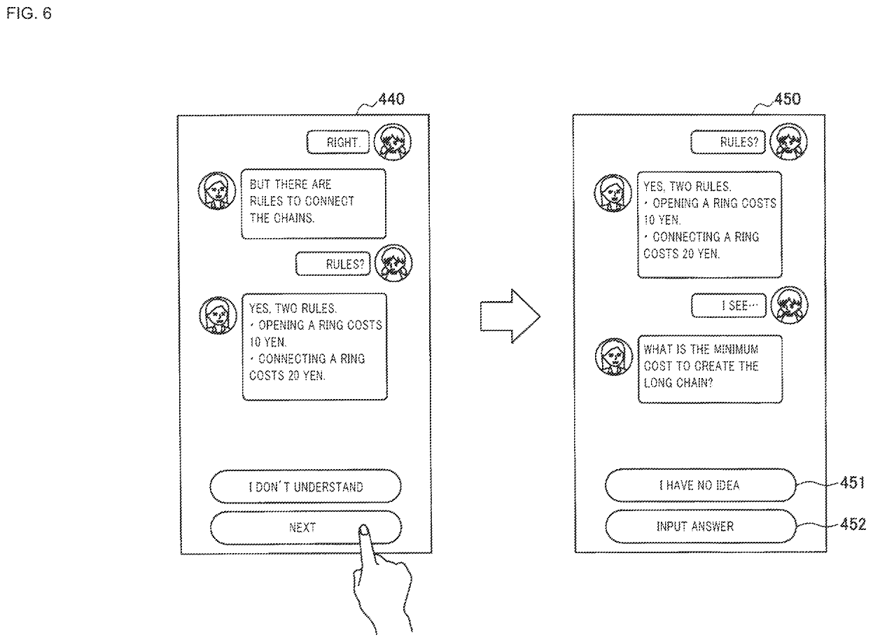

In addition, as shown on a screen 430 in FIG. 5 and screens 440 and 450 in FIG. 6, the display control unit 202 performs control for displaying a next conversation sentence every time the learner maps a “next” button. Once the screen 450 in FIG. 6 is read, an “input answer” button 452 is displayed and the learner is able to input an answer. When the learner does not know the answer, the learner taps an “I have no idea” button 451. When the “I have no idea” button 451 is tapped, the question management server 2 may display hint information registered in advance or a similar question with a lower level of difficulty or may issue a notification to the teacher terminal 4.

Next, setting of meta-information related to question data such as hint information and similar-question information will be described. The meta-information setting unit 203 according to the present embodiment can set as meta-information, to question data, hint information (an explanatory text to help comprehend the question), level of difficulty information (a level of difficulty of the question which can be corrected as needed in accordance with a rate of correct answers), similar-question information (such as an ID of a similar question), a question category (for example, a keyword (two-digit addition, multiplication, tsuru-kame zan (crane and turtle calculation: a question of obtaining respective numbers of cranes and turtles from a total of their heads and legs), or the like) pertaining to knowledge addressed in the question or a keyword (two-digit addition, multiplication, tsuru-kame zan, or the like) pertaining to knowledge on which the question is premised), and the like.

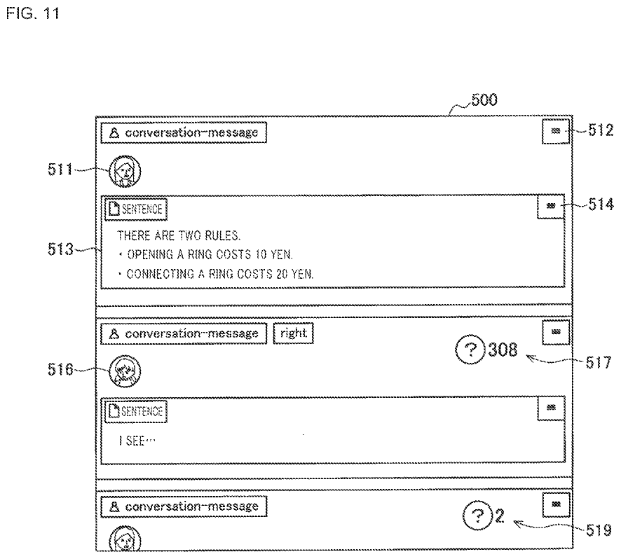

Meta-information may be set by a creator of the question or may be individually set by a teacher using the question data. Meta-information may be appropriately set in association with each conversation sentence generated by decomposing question statement data (text data) included in the question data. Setting of meta-information on the teacher terminal 4 will be described later with reference to FIG. 11. When displaying a conversation with which registered advice information such as hint information and similar-question information is associated, the display control unit 202 displays an “I don't understand” button so that the learner can make an advice request as needed. Processing when the “I don't understand” button is selected will be described below with reference to FIG. 7.

FIG. 7 is a diagram for explaining an example of display of hint information having been registered in advance. As shown in FIG. 7, when the “I don't understand” button 426 on the screen 420 is tapped, a learner icon image 461 and a speech bubble image 462 showing a line such as “Hmm . . . Can you explain it to me in more detail?” are displayed as shown on a screen 460 and, further, a teacher icon image 463 and a speech bubble image 464 showing hint information are displayed. When questions are resolved by the hint information, the learner taps a “next” button 465. When the “next” button 465 is tapped, the display control unit 202 displays a continuation of the question statement (for example, the screen 430 in FIG. 5). An “I don't understand” button may be displayed on the screen 460 displaying hint information when further hint information or a similar-type question is set, when a notification can be issued to the teacher terminal 4, or simply in order to assess comprehension by the learner.

In addition, the display control unit 202 may display hint information corresponding to the comprehension by the learner. The comprehension can be calculated by the comprehension calculating unit 205 based on previous learning history (for example, a percentage of correct answers, progress of learning, or parts where an “I don't understand” button has been operated) of the learner. It should be noted that the comprehension calculating unit 205 may present a similar-type question, calculate comprehension by a learner based on an answer to the similar-type question, and display corresponding hint information (for example, present a similar-type question with a lower level of difficulty than a present question and display hint information for a case where a correct answer is provided or hint information for a case where an incorrect answer is provided).

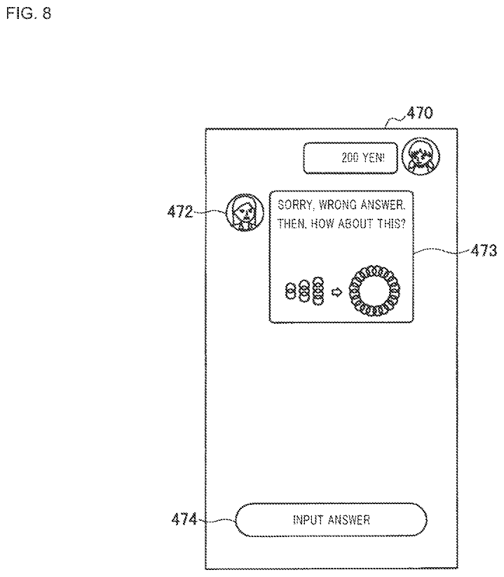

In the present embodiment, even when an answer input by tapping the “input answer” button 452 on the screen 450 shown in FIG. 6 is incorrect, hint information or a similar question registered in association with the question may be displayed. FIG. 8 is a diagram for explaining an example in which, when an answer to a question is incorrect, a similar-type question which has been registered in advance and which has a lower level of difficulty than the present question is displayed.

As shown on a screen 470 in FIG. 8, when an answer input by a learner is incorrect, the display control unit 202 displays a teacher icon image 472 and a speech bubble image 473 showing a similar-type question having a lower level of difficulty than the present question. Accordingly, a transition to a similar question can be performed in a smooth manner. When inputting an answer to the similar question, the learner can tap an “input answer” button 474 shown on the screen 470 to input the answer.

In addition, in doing so, the display control unit 202 can also appropriately select a similar-type question to be displayed in accordance with a manner in which an answer to the question had been incorrect. For example, several similar questions are presented which are related to knowledge (a keyword) being addressed in the present question and which have a lower level of difficulty than the present question. When an incorrect answer to these similar questions is provided a plurality of times, the display control unit 202 presents a question that addresses prerequisite knowledge of the present question as a similar question. Prerequisite knowledge can be set to the present question in advance as a piece of meta-information.

While control for displaying an “I don't understand” button at a part where hint information or a similar question has been registered in advance is performed as an example in the present embodiment, the present embodiment is not limited to this example and, for example, the “I don't understand” button may be constantly displayed so as to enable a state of comprehension by the learner to be collected at all times.

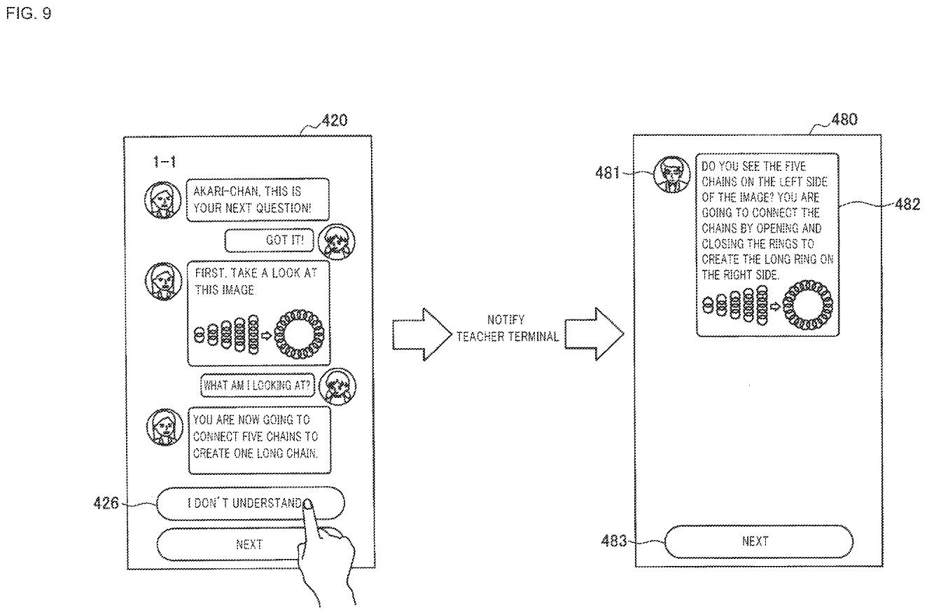

When an “I don't understand” button displayed at a part where hint information has not been registered is tapped, the control unit 200 stores (as a learner action or learner history) the fact that the “I don't understand” button has been operated in the storage unit 220 and, at the same time, notifies the teacher terminal 4, makes a transition to a similar question to the present question, or switches to a next question. When a teacher checks an answer status of a student (a learner) in real time, the teacher terminal 4 may be notified so that the teacher can directly respond to a part where the student is unable to comprehend. A case where the teacher provides a direct response in this manner will be explained with reference to FIG. 9.

FIG. 9 is a diagram for explaining an example of a case of notifying the teacher terminal 4 when an “I don't understand” button is tapped. As shown on the screen 420 in FIG. 9, when the “I don't understand” button 426 is tapped, the question management server 2 notifies the teacher terminal 4 (notifies that a student is in an incomprehensive state). The teacher operating the teacher terminal 4 can manually input an explanatory text. As shown on a screen 480 in FIG. 9, the input explanatory text is displayed as a speech bubble image 482 together with a teacher icon image 481 (in this case, an icon image of an actual teacher may be displayed in order to convey the fact that the teacher is responding in real time).

In addition, an input mode of a student (learner) on the answer terminal 1 can also be switched to another input mode from the teacher terminal 4. For example, when free input by the student on the answer terminal 1 is permitted, the student can ask questions and provide answers while engaging in free conversation with the teacher (in other words, while manually inputting messages) on the conversation screen.

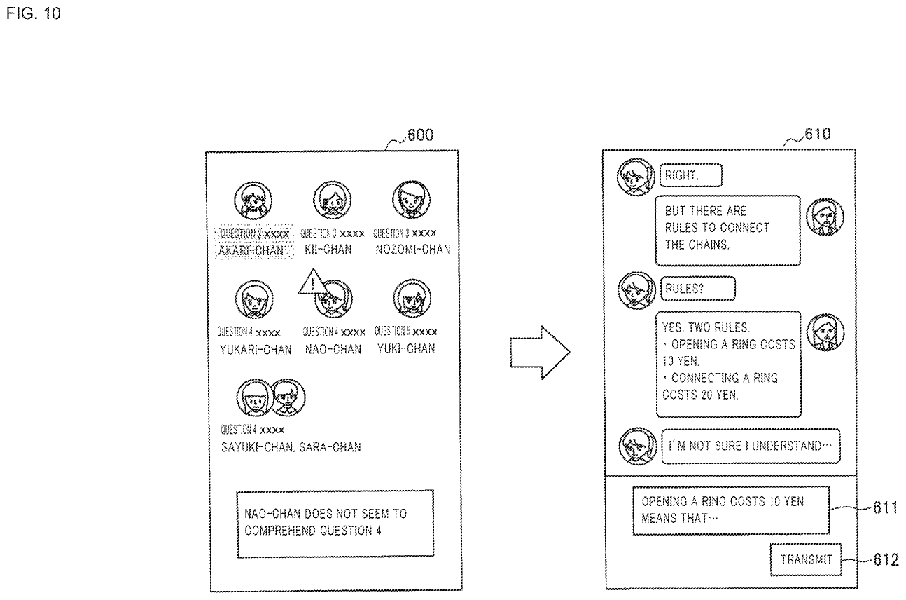

FIG. 10 is a diagram showing an example of a display screen of the teacher terminal 4. As shown on a screen 600, progress information on participating learners is displayed as a list using, for example, learner icon images on the teacher terminal 4. For example, a question currently being solved is displayed as progress information. When progress has fallen behind (for example, compared to other learners), the lag in progress may be explicitly indicated by a warning icon, a message, a background color or a character color, or the like. On the screen 600, since the progress of “Akari-chan” has fallen behind other students, progress information of “Akari-chan” is displayed in a different background color.

In addition, as explained with reference to FIG. 9, a case where a learner operates an “I don't understand” button and issues a notification to the teacher may also be explicitly indicated by a warning icon, a message, a background color or a character color, or the like. On the screen 600, the fact that “Nao-chan” is in a state where she does not comprehend the question is notified by a warning icon and a message.

A case where learners are participating as a group (a plurality of persons) can also be envisaged. In this case, for example, pluralities of icon images and names such as “Sayuki-chan, Sara-chan” on the screen 600 are displayed.

By clicking a learner icon image, a screen transition is made to a conversation screen with the learner. For example, by clicking an icon image of “Nao-chan” being displayed on the screen 600 in FIG. 10, a screen transition is made to a screen 610 that is a conversation screen with “Nao-chan”. “Nao-chan” is in a state where an “I don't understand” button has been operated, and the teacher can freely transmit a message by manually inputting an explanatory text in a message input field 611 and tapping a “transmit” button 612.

The control unit 200 may register an explanatory text input (replied) by the teacher in association with a conversation sentence as new meta-information (hint information). Accordingly, when a student subsequently touches the “I don't understand” button at a same part, the registered explanatory text can be presented.

In addition, even at a part where an explanatory text has been registered in advance, the control unit 200 may issue a notification to the teacher terminal 4 and, when there is no response within a certain period of time, display the explanatory text having been registered in advance.

Furthermore, when there are a plurality of explanatory texts having been registered in advance, an explanatory text with a high rate of correct answers may be preferentially selected in accordance with a subsequent rate of correct answers of a learner.

A registration method of meta-information will now be explained with reference to FIG. 11. FIG. 11 is a diagram showing an example of a question editing screen according to the present embodiment. A screen 500 in FIG. 11 is a screen (a question editing screen) for editing question statement data having been automatically converted into a conversational format by the question statement converting unit 201. For example, the question statement data is displayed on the teacher terminal 4 or a creator terminal (not illustrated) and can be edited by a teacher or a creator.

The screen 500 shown in FIG. 11 sequentially displays each conversation “conversation-message” (a sentence or an image displayed in a speech bubble) based on question statement data. In addition, an icon image (a teacher icon image 511, a learner icon image 516, or the like) that is displayed in correspondence to each conversation is shown. Furthermore, for example, when a basic rule is to display an icon image and a speech bubble on a left side of the conversation screen, since a conversation by the learner such as a backchannel response is to be displayed on a right side, “right” is displayed. When editing an icon image, a display position, or the like, editing can be performed by clicking an edit icon 512. In addition, when editing contents of a conversation, editing can be performed by clicking an edit icon 514. Furthermore, when registering meta-information, registration can be performed by clicking the edit icon 514 at a part where a conversation (such as a sentence 513) to be associated with the meta-information is being displayed.

Such editing may be performed in an initial stage or a stage after a certain amount of learning has been performed. On the screen 500, parts where the “I don't understand” button has been pressed by a learner and the number of learners are explicitly indicated by a numerical value, a size of an icon, a color, a type, or the like (for example, displays 517 and 519 of the number of persons with questions being displayed on the screen 500). Accordingly, for example, a teacher can register hint information or similar-question information at a part where a learner is likely to stumble.

The learner information managing unit 204 records information related to a learner such as a profile (a name, age, gender, an icon image, and the like) of the learner and a learning history (contents of answers, a percentage of correct answers, learning progress, comprehension, and the like) in the storage unit 220 and manages the information. The learning history includes operation history such as where the “I don't understand” button has been tapped (in other words, where in the conversation an advice request operation has been performed). Recording such an operation history enables how far a learner has read a question (how much of the question the learner has comprehended) to be assessed more accurately.

The comprehension calculating unit 205 calculates comprehension of learning based on the learning history of a learner. For example, the comprehension calculating unit 205 may calculate comprehension based on a percentage of correct answers of a question or progress (learning progress). In addition, the comprehension calculating unit 205 according to the present embodiment can more accurately calculate comprehension of learning based on how much a learner has comprehended a question statement or, in other words, a timing of an advice request operation (which part of a conversation the “I don't understand” button was tapped).

Conventionally, while question statement data was displayed on a single screen (or displayed across a plurality of screens by scrolling or the like) as shown in FIG. 3, in the present embodiment, question statement data is sequentially displayed in a conversational format as shown in FIGS. 4 to 6 and, when a learner is able to comprehend a question statement, a “next” button is tapped to advance the conversation. When a learner is unable to comprehend the question statement, the learner taps the “I don't understand” button that is being displayed at that time point to obtain hint information or the like. In the present system, question statement data is sequentially displayed in a conversational format in this manner and, at the same time, how much a learner has comprehended a question statement can be more accurately assessed based on a timing of an advice request operation such as a tap of the “I don't understand” button. It should be noted that an “advice request operation” is not limited to a tap operation of the “I don't understand” button and may be a predetermined operation indicating that a learner is unable to comprehend contents and is asking for advice.

Comprehension calculated by the comprehension calculating unit 205 is registered in the storage unit 220 as learner information. In addition, the teacher terminal 4 may be notified of the comprehension of a learner. Furthermore, the comprehension calculating unit 205 may update comprehension from time to time in accordance with a progress of a learner. In addition, in accordance with the calculated comprehension, the display control unit 202 is also capable of changing a level of difficulty of a question to be presented to a learner or present an appropriate explanatory text or commentary. Furthermore, in accordance with the calculated comprehension, the display control unit 202 is capable of improving a question statement, appropriately selecting a next question, or dynamically presenting a similar question.

(Communication Unit 210)

The communication unit 210 transmits and receives data to and from an external apparatus in a wired or wireless manner. The communication unit 210 is communicatively connected to the network 3 by a wired/wireless LAN (Local Area Network), Wi-Fi (registered trademark), Bluetooth (registered trademark), a mobile communication network (LTE (Long Term Evolution) or 3G (third-generation mobile telecommunications system)), or the like and is capable of transmitting and receiving data to and from the answer terminal 1 or the teacher terminal 4 via the network 3.

(Storage Unit 220)

The storage unit 220 is realized by a ROM (Read Only Memory) for storing programs, operation parameters, and the like to be used in processing by the control unit 200 and a RAM (Random Access Memory) for temporarily storing parameters and the like that change from time to time.

This concludes the detailed description of the configuration of the question management server 2 according to the present embodiment. The configuration of the question management server 2 shown in FIG. 2 is merely an example and the present embodiment is not limited thereto. For example, a least a part of components of the question management server 2 may reside in an external apparatus or a least a part of respective functions of the control unit 200 may be realized by the answer terminal 1 or an information processing terminal (for example, a so-called edge server) of which a communication distance is relatively close to the answer terminal 1. For example, the question management server 2 need not necessarily have the question statement converting unit 201 and data converted by the question statement converting unit 201 provided in an external apparatus (for example, another server) may be transmitted to the question management server. In addition, the respective components of the control unit 200 and the storage unit 220 shown in FIG. 2 may be provided in the answer terminal 1 and all of the steps of processing by the learning support system according to the present embodiment may be executed by applications residing in the answer terminal 1.

<3. Operation Processing>

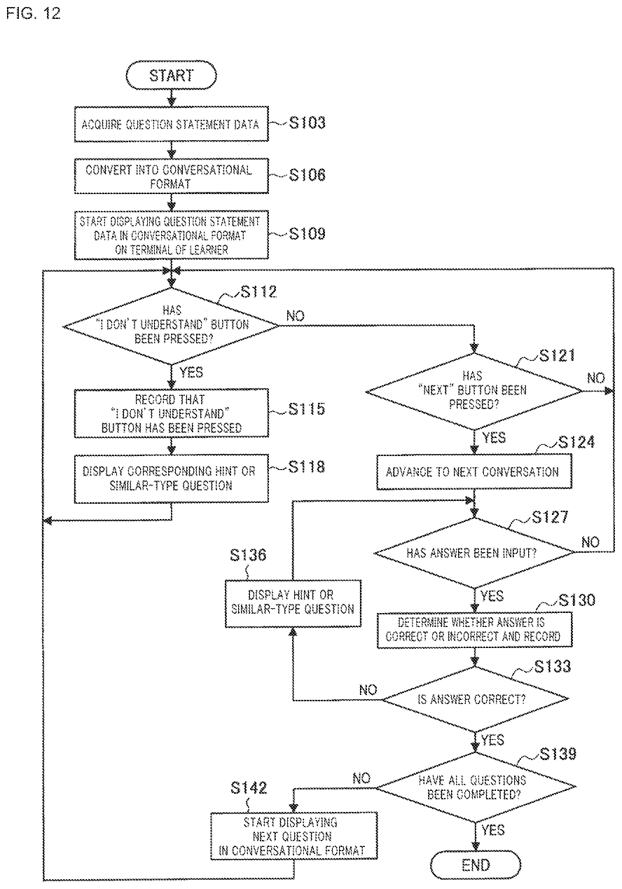

Next, operation processing of the learning support system according to the present embodiment will be described with specificity with reference to FIG. 12. FIG. 12 is a flow chart showing an example of a flow of operation processing of the learning support system according to the present embodiment.

As shown in FIG. 12, first, the question management server 2 acquires question statement data (step S103). The question statement data may be input by a creator or a teacher from an information processing terminal (the teacher terminal 4 or the like), registered in the storage unit 220, or acquired from the network.

Next, the question statement converting unit 201 of the question management server 2 converts the question statement data into a conversational format (step S106).

Next, the display control unit 202 of the question management server 2 starts displaying a question statement in a conversational format on a terminal (the answer terminal 1) of a learner (step S109). Specifically, for example, the display control unit 202 causes the screen 400 in FIG. 4 to be displayed on the answer terminal 1.

Next, when an “I don't understand” button is pressed (No in step S112) or when a “next” button is pressed (Yes in step S121), the display control unit 202 proceeds to a next conversation (step S124). Specifically, for example, when the “next” button 403 displayed on the screen 400 in FIG. 4 is tapped, the display control unit 202 causes a transition to be made to the screen 410 in FIG. 4. On the screen 410, the learner icon image 411 and the speech bubble image 412 indicating a backchannel response are displayed and, subsequently, the teacher icon image 413 and the speech bubble image 414 indicating a next conversation are displayed.

Every time the “next” button is pressed, the display control unit 202 sequentially displays a next conversation while inserting backchannel responses or the like (refer to FIGS. 4 to 6).

Next, when the “I don't understand” button displayed on the conversation screen is pressed (tapped, clicked, or the like) (Yes in step S112), the learner information managing unit 204 records the fact that the “I don't understand” button has been pressed as learner history of the learner (step S115).

Next, the display control unit 202 displays hint information or a similar-type question registered in correspondence to a part where the “I don't understand” button has been pressed (step S118). Specifically, for example, as shown on the screen transition diagram in FIG. 7, when the “I don't understand” button 426 displayed on the screen 420 has been pressed, the display control unit 202 displays the speech bubble image 464 indicating corresponding hint information as shown on the screen 460.

Subsequently, when an answer is input (Yes in step S127), the control unit 200 determines whether the answer is correct or incorrect and records the answer in the storage unit 220 as learning history (step S130).

Next, in the case of an incorrect answer (No in step S133), the display control unit 202 displays a hint or a similar-type question registered in correspondence to the incorrect answer (step S136).

On the other hand, in the case of a correct answer (Yes in step S133), until all questions are completed (step S139), the display control unit 202 continuously starts displaying a next question in a conversational format (step S142).

This concludes the description of an example of the operation processing according to the present embodiment. It should be noted that the operation processing shown in FIG. 12 is simply an example and that the present disclosure is not limited to the example shown in FIG. 12. For example, the present disclosure is not limited to an order of steps shown in FIG. 12. At least any of the steps may be processed in parallel or processed in reverse order. In addition, all of the processing steps shown in FIG. 12 need not necessarily be executed. Furthermore, all of the processing steps shown in FIG. 12 need not necessarily be performed by a single apparatus.

Specifically, for example, the display control unit 202 may perform control so that an “I don't understand” button is displayed at a part where corresponding hint information or similar-question information is being registered. In addition, when hint information or similar-question information is not registered at a part where the “I don't understand” button has been pressed, the display control unit 202 may notify the teacher terminal 4.

<4. Example of Application to Learning in Group Format>

Next, a case where display of question data in a conversational format is applied to learning in a group format will be described. In learning in a group format, a same question can be solved by a plurality of persons and a question or the like is to be shared by all.

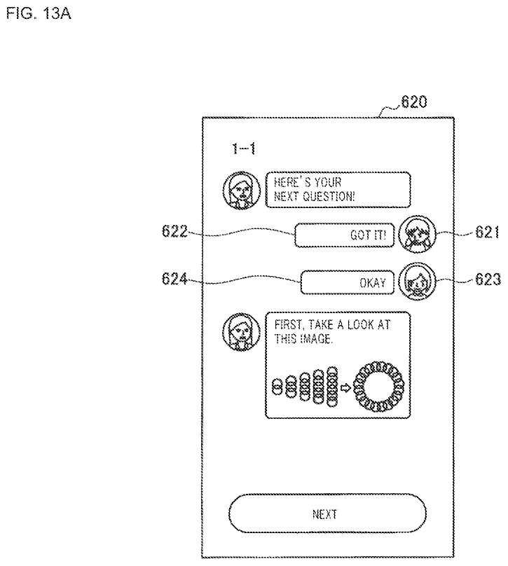

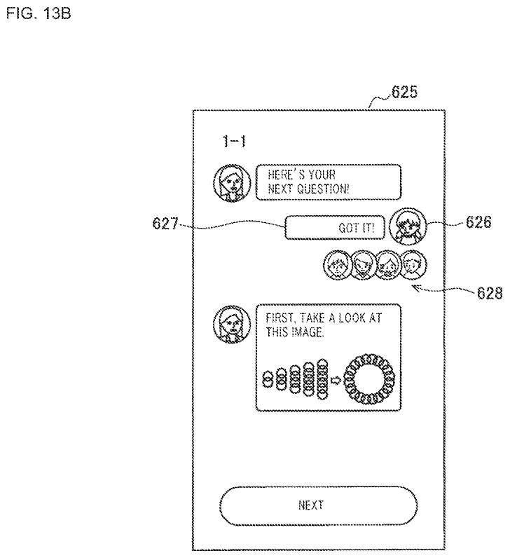

In a case of learning in a group format as described above, question data is sequentially displayed in a conversational tone on a conversation screen in which a plurality of learners participate. On a screen of the answer terminal 1 owned by each learner, a teacher icon image, a conversation by a teacher notifying a start of a question, and a “next” button are displayed in a similar manner to that shown on the screen 400 in FIG. 4. When each learner taps the “next” button, as shown on a screen 620 in FIG. 13A, icon images 621 and 623 of the respective learners having tapped the “next” button and speech bubble images 622 and 624 indicating corresponding backchannel responses are respectively displayed.

Accordingly, one of the learners can acknowledge that other learners in the group have also comprehended.

When there are many participants, as shown on a screen 625 in FIG. 13B, in addition to displaying an icon image 626 of a learner himself/herself and a speech bubble image 627 indicating a backchannel response, an icon group image 628 which bundles icon images of the other learners may be displayed.

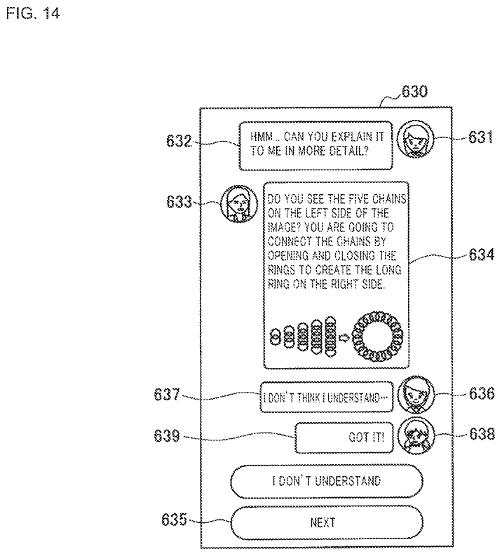

In addition, when one learner presses an “I don't understand” button, a question is shared among all of those participating in group learning. FIG. 14 is a diagram for explaining a display example when the “I don't understand” button is pressed during learning in a group format. For example, when another learner has pressed the “I don't understand” button as shown on the screen 630 in FIG. 14, an icon image 631 of the learner and a speech bubble image 632 indicating a question are displayed on a conversation screen shown on the answer terminals 1 of all participants.

In addition, in accordance with pressing of the “I don't understand” button, a speech bubble image 634 indicating corresponding hint information is displayed together with the teacher icon image 633 on the conversation screen of the answer terminal 1 of all participants.

When a learner having comprehended the hint information presses the “next” button 635, a learner icon image 638 and a speech bubble image 639 indicating a backchannel response are displayed on the conversation screen of the answer terminal 1 of all participants. On the other hand, when a learner unable to comprehend the hint information presses the “I don't understand” button, a speech bubble image 637 indicating the fact that the learner is unable to comprehend and an icon image 636 are displayed on the conversation screen of the answer terminal 1 of all participants.

Accordingly, who among the participants comprehends and who does not comprehend at what stage in a step of reading the question statement can be mutually acknowledged. A similar screen can also be viewed on the teacher terminal 4 and, accordingly, a teacher can acknowledge who among the participants comprehends and who does not comprehend at what stage in a step of reading the question statement.

In addition, answer information can be hidden from other participants depending on settings. Conceivable settings related to display of answer information include display all, display incorrect answers but hide correct answers, and hide all. Alternatively, the teacher or the like may set whether to display or hide answers as appropriate.

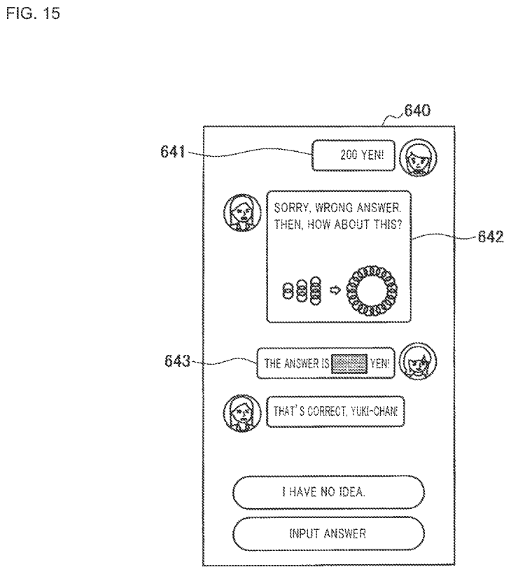

When “display incorrect answers but hide correct answers” is set, for example, as shown in FIG. 15, an incorrect answer input by another learner is displayed in a speech bubble image 641. On the other hand, a correct answer input by another learner is hidden in a speech bubble image 643 (for example, by using a blank space, flood-filling, or redaction). In addition, a speech bubble image 642 indicating hint information or a similar question with a lower level of difficulty with respect to a person having provided an incorrect answer is also shared by all participants.

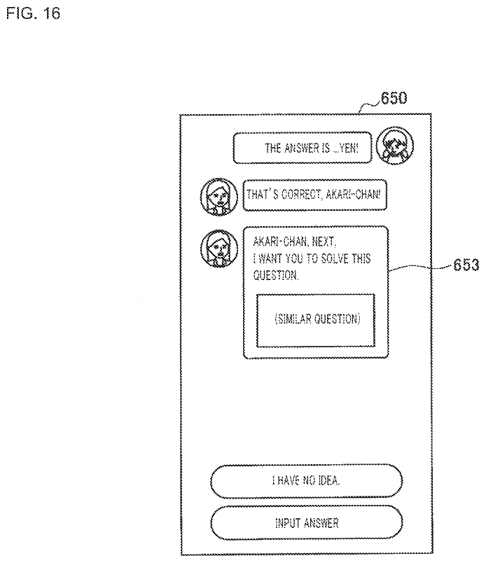

In addition, with respect to a learner having provided a correct answer ahead of time, a similar question with a same or a higher level of difficulty may be presented in consideration of comprehension by the learner, a remaining time, or the like in order to make efficient use of time. A similar question may only be displayed to persons having provided a correct answer. FIG. 16 is a diagram for explaining a case where a similar question is presented to a person having provided a correct answer. A screen 650 in FIG. 16 is, for example, a conversation screen on the answer terminal 1 used by “Akari-chan”, and when “Akari-chan” inputs an answer and the answer is correct, a speech bubble image 653 indicating a similar question with a same or a higher level of difficulty is displayed in accordance with a remaining time or the like. Accordingly, “Akari-chan” can use the time it takes for other learners participating in group learning to provide an answer to solve a new question and therefore advance her learning.

Messages (speech bubble images) displayed on a conversation screen in the group learning described above may be stored in the storage unit 220 or the like together with time information (storage of what kind of message is displayed at what timing). Accordingly, even in a case where a different learner is to solve a question afterwards by himself/herself, by reproducing a flow of these messages, a student unable to participate in group learning such as a class in real time can solve the question in a same kind of environment.

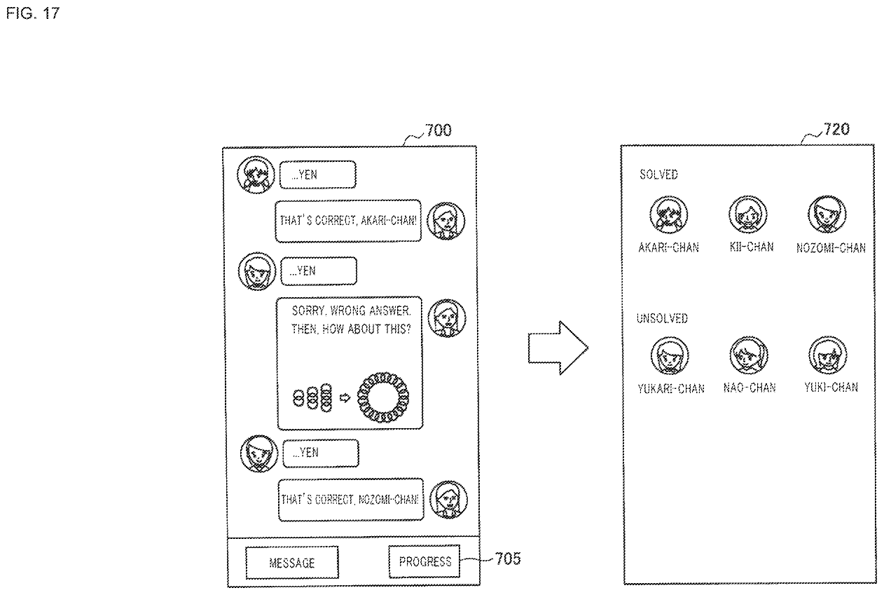

In addition, the teacher terminal 4 can confirm progress (a status) of participants of group learning using a list. FIG. 17 is a diagram for explaining a list screen of participant progress during learning in a group format. As shown on a screen 700 in FIG. 17, a progress button 705 is displayed on a conversation screen displayed on the teacher terminal 4. When the progress button 705 is tapped, as shown on a right side of FIG. 17, a screen 720 showing progress of participants in group learning as a list is displayed. On the screen 720, for example, learners who have already provided an answer and learners who have not yet provided an answer are clearly indicated by icon images.

<5. Summary>

As described above, with an information processing system according to the embodiment of the present disclosure, a sense of immersion to a question can be imparted and comprehension of a learner can be more appropriately calculated by sequentially displaying a question statement in a conversational format.

The display in a conversational format according to the present embodiment may be applied when displaying commentary data.

While a preferred embodiment of the present disclosure has been described in detail with reference to the accompanying drawings, the present technique is not limited thereto. It will be obvious to a person with ordinary skill in the art to which the technical field of the present disclosure pertains that various modifications and changes can be arrived at without departing from the technical ideas as set forth in the appended claims and, as such, it is to be understood that such modifications and changes are to be naturally covered in the technical scope of the present disclosure.

For example, a computer program can also be created which causes hardware such as a CPU, a ROM, and RAM that are built into the answer terminal 1, the question management server 2, or the teacher terminal 4 described above to fulfill functions of the answer terminal 1, the question management server 2, or the teacher terminal 4. In addition, a computer-readable storage medium storing the computer program is also provided.

Furthermore, the advantageous effects described in the present specification are merely descriptive or exemplary and not restrictive. In other words, the technique according to the present disclosure can produce, in addition to or in place of the advantageous effects described above, other advantageous effects that will obviously occur to those skilled in the art from the description of the present specification.

The present technique can also be configured as follows.

(1)

An information processing apparatus including a control unit configured to: perform control for sequentially displaying question data in a conversational format;

control display in the conversational format so as to proceed in accordance with a transition trigger operation by a learner;

record a part where an advice request operation has been performed by the learner with respect to the display in the conversational format being sequentially displayed; and

calculate comprehension of the learner based on a part where the advice request operation has been performed.

(2)

The information processing apparatus according to (1), wherein

the control unit is configured to

perform processing for converting acquired question data into a conversational format.

(3)

The information processing apparatus according to (2), wherein

the control unit is configured to

divide the question data and change a style of a text into a conversational tone as the conversion processing into a conversational format.

(4)

The information processing apparatus according to (3), wherein

the control unit is configured to

further automatically insert a backchannel response by the learner as the conversion processing into a conversational format.

(5)

The information processing apparatus according to (4), wherein

the control unit is configured to

display a conversation based on the question data in association with an icon image of a presenter of the question, and

display the backchannel response in association with an icon image of a learner when the transition trigger operation is performed and display a next conversation based on the question data in association with the icon image of a presenter of the question.

(6)

The information processing apparatus according to any one of (1) to (5), wherein

the control unit is configured to

display, when the advice request operation is performed, advice information registered in advance in association with the advice request operation.

(7)

The information processing apparatus according to (6), wherein

the control unit is configured to

display hint information as the advice information.

(8)

The information processing apparatus according to (6), wherein

the control unit is configured to

display a similar question as the advice information.

(9)

The information processing apparatus according to any one of (1) to (5), wherein

the control unit is configured to

notify a teacher terminal when the advice request operation is performed.

(10)

The information processing apparatus according to (9), wherein

the control unit is configured to

display advice information registered in association with a part where the advice request operation had been performed when there is no response from the teacher terminal for a certain period of time.

(11)

The information processing apparatus according to any one of (1) to (10), wherein

the control unit is configured to

perform control for displaying, as progress of one or more learners, a learner progress list screen that clearly indicates a learner having performed the advice request operation on a teacher terminal.

(12)

The information processing apparatus according to any one of (1) to (11), wherein

the display in the conversational format is shared by information processing terminals of a plurality of learners participating in group learning.

(13)

An information processing method including the steps carried out by a processor of:

performing control for sequentially displaying question data in a conversational format;

controlling display in the conversational format so as to proceed in accordance with a transition trigger operation by a learner;

recording a part where an advice request operation has been performed by the learner with respect to the display in the conversational format being sequentially displayed; and

calculating comprehension of the learner based on a part where the advice request operation has been performed.

(14)

A program for causing a computer to function as a control unit configured to:

perform control for sequentially displaying question data in a conversational format;

control display in the conversational format so as to proceed in accordance with a transition trigger operation by a learner;

record a part where an advice request operation has been performed by the learner with respect to the display in the conversational format being sequentially displayed; and

calculate comprehension of the learner based on a part where the advice request operation has been performed.

### REFERENCE SIGNS LIST

1 Answer terminal
2 Question management server
200 Control unit
201 Question statement converting unit
202 Display control unit
203 Meta-information setting unit
204 Learner information managing unit
205 Comprehension calculating unit
210 Communication unit
220 Storage unit

1. An information processing apparatus, comprising a control unit configured to:
perform control for sequentially displaying question data in a conversational format;
control display in the conversational format so as to proceed in accordance with a transition trigger operation by a learner;
record a part where an advice request operation has been performed by the learner with respect to the display in the conversational format being sequentially displayed; and
calculate comprehension of the learner based on a part where the advice request operation has been performed.

2. The information processing apparatus according to claim 1, wherein
the control unit is configured to
perform processing for converting acquired question data into a conversational format.

3. The information processing apparatus according to claim 2, wherein
the control unit is configured to
divide the question data and change a style of a text into a conversational tone as the conversion processing into a conversational format.

4. The information processing apparatus according to claim 3, wherein
the control unit is configured to
further automatically insert a backchannel response by the learner as the conversion processing into a conversational format.

5. The information processing apparatus according to claim 4, wherein
the control unit is configured to
display a conversation based on the question data in association with an icon image of a presenter of the question, and
display the backchannel response in association with an icon image of a learner when the transition trigger operation is performed and display a next conversation based on the question data in association with the icon image of a presenter of the question.

6. The information processing apparatus according to claim 1, wherein
the control unit is configured to
display, when the advice request operation is performed, advice information registered in advance in association with the advice request operation.

7. The information processing apparatus according to claim 6, wherein
the control unit is configured to
display hint information as the advice information.

8. The information processing apparatus according to claim 6, wherein
the control unit is configured to
display a similar question as the advice information.

9. The information processing apparatus according to claim 1, wherein
the control unit is configured to
notify a teacher terminal when the advice request operation is performed.

10. The information processing apparatus according to claim 9, wherein
the control unit is configured to
display advice information registered in association with a part where the advice request operation had been performed when there is no response from the teacher terminal for a certain period of time.

11. The information processing apparatus according to claim 1, wherein
the control unit is configured to
perform control for displaying, as progress of one or more learners, a learner progress list screen that clearly indicates a learner having performed the advice request operation on a teacher terminal.

12. The information processing apparatus according to claim 1, wherein the display in the conversational format is shared by information processing terminals of a plurality of learners participating in group learning.

13. An information processing method comprising the steps carried out by a processor of:
performing control for sequentially displaying question data in a conversational format;
controlling display in the conversational format so as to proceed in accordance with a transition trigger operation by a learner;
recording a part where an advice request operation has been performed by the learner with respect to the display in the conversational format being sequentially displayed; and
calculating comprehension of the learner based on a part where the advice request operation has been performed.

14. A program for causing a computer to function as a control unit configured to:
perform control for sequentially displaying question data in a conversational format;
control display in the conversational format so as to proceed in accordance with a transition trigger operation by a learner;
record a part where an advice request operation has been performed by the learner with respect to the display in the conversational format being sequentially displayed; and
calculate comprehension of the learner based on a part where the advice request operation has been performed.
